(19) United States
(12) Patent Application Publication
(10) Pub. No.: US 2026/0066474 A1
(43) Pub. Date: Mar. 5, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: Hye Won KIM, Daejeon (KR); In Hyouk SUNG, Daejeon (KR); Jin Young SHIN, Daejeon (KR); So Young YOON, Daejeon (KR); Kyung Ryun KA, Daejeon (KR)

(73) Assignee: LG ENERGY SOLUTION, LTD., Seoul (KR)

(21) Appl. No.: 19/317,534

(22) Filed: Sep. 3, 2025

(30) Foreign Application Priority Data
Sep. 4, 2024 (KR) 10-2024-0120067
Aug. 21, 2025 (KR) 10-2025-0116288

(51) Int. Cl. H01M 50/491; H01M 10/0525; H01M 50/406; H01M 50/423; H01M 50/426; H01M 50/434; H01M 50/451

(52) U.S. Cl. CPC H01M 50/491; H01M 10/0525; H01M 50/406; H01M 50/423; H01M 50/426; H01M 50/434; H01M 50/451

(57) ABSTRACT

A separator for an electrochemical device includes a porous polymer substrate; and a coating layer disposed on at least one surface of the porous polymer substrate and including inorganic particles. The porous polymer substrate has a porosity of about 50 vol % or more and 65 vol % or less, the porous polymer substrate includes a polymer having a melt index of about 0.0001 g/10 min or more and 0.01 g/10 min or less, and the coating layer has a porosity of about 40 vol % or more and 70 vol % or less.

### CROSS-REFERENCE TO RELATED APPLICATIONS

This application is based on and claims priority from Korean Patent Application No. 10-2024-0120067 filed on Sep. 4, 2024, and No. 10-2025-0116288 filed on Aug. 21, 2025, with the Korean Intellectual Property Office, the disclosure of which is incorporated herein in its entirety by reference.

### TECHNICAL FIELD

The present disclosure relates to a separator for an electrochemical device and an electrochemical device including the same.

### BACKGROUND

An electrochemical device converts chemical energy into electrical energy through an electrochemical reaction. In recent years, lithium secondary batteries, which provide high energy density and voltage, long cycle life, and applicability across various fields, have been widely adopted.

A lithium secondary battery generates electricity through a chemical reaction in which lithium ions migrate between a positive electrode active material and a negative electrode active material, and the battery is charged as lithium ions of the positive electrode migrate to the negative electrode and discharges while releasing energy as lithium ions of the negative electrode move back to the positive electrode. In this case, an electrolyte serving as a pathway for the migration of lithium ions between the positive electrode and the negative electrode, and a separator preventing the positive electrode and the negative electrode from coming into contact with each other, are required. In general, the four components of a lithium ion battery refer to the positive electrode active material, the negative electrode active material, the electrolyte, and the separator.

### SUMMARY

The present disclosure provides a separator for an electrochemical device including a porous polymer substrate having a high porosity and a coating layer, in which the porous polymer substrate includes a polymer having a low melt index (MI), so that the separator for an electrochemical device exhibits a low resistance and excellent mechanical strength.

The present disclosure provides a separator for an electrochemical device including a porous polymer substrate and a coating layer disposed on at least one surface of the porous polymer substrate and including inorganic particles, in which the porous polymer substrate has a porosity of about 50 vol % to 65 vol %, the porous polymer substrate includes a polymer having a melt index of about 0.0001 g/10 min to 0.01 g/10 min, and the coating layer has a porosity of about 40 vol % to 70 vol %.

The polymer in the porous polymer substrate may have a crystallinity of 60% or more and 90% or less.

The polymer in the porous polymer substrate may have a weight average molecular weight of about 1,500,000 g/mol or more and 2,500,000 g/mol or less.

The polymer in the porous polymer substrate may be one or more selected from polyethylene, polypropylene, polybutylene, polyvinyl chloride, polyethylene terephthalate, polycycloolefin, polyethersulfone, polyamide, polyimide, polyamide imide, nylon, and polytetrafluoroethylene.

The inorganic particles included in the coating layer may have a cubic shape.

The inorganic particles included in the coating layer may have an average particle diameter (D₅₀) of 200 nm or more and 1 μm or less.

The inorganic particles included in the coating layer may be one or more selected from boehmite (γ-AlO(OH)), alumina (Al₂O₃), BaTiO₃, Pb(Zr,Ti)O₃ (PZT), Pb₁₋ₓLaₓZr_{1-y}TiNO₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al(OH)₃, TiO₂, aluminum peroxide, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅).

A content of the inorganic particles may be about 90 parts by weight or more based on 100 parts by weight of the total weight of the coating layer.

The coating layer may further include a binder, and a content of the binder may be about 1 part by weight or more and 10 parts by weight or less based on 100 parts by weight of the total weight of the coating layer.

A thickness of the porous polymer substrate may be about 4 μm or more and 20 μm or less.

A thickness of the coating layer may be about 0.5 μm or more and 4 μm or less.

The present disclosure provides an electrochemical device including a positive electrode, a negative electrode, and the separator for an electrochemical device, in which the separator is interposed between the positive electrode and the negative electrode.

The present disclosure provides a method for manufacturing a separator for an electrochemical device. The method includes: (S10) a step of extruding a polymer sheet composition including a polymer and a diluent; (S20) a step of molding and stretching the extruded polymer sheet composition into a sheet form; (S30) a step of extracting the diluent from the polymer sheet extruded in step S20 to prepare a porous polymer substrate; (S40) a step of heat-setting the porous polymer substrate; and (S50) a step of forming a coating layer including inorganic particles on at least one surface of the porous polymer substrate, in which the polymer of the porous polymer substrate has a melt index of about 0.0001 g/10 min or more and 0.01 g/10 min or less, and a content of the diluent is about 70 parts by weight or more and 90 parts by weight or less based on 100 parts by weight of the total polymer sheet composition.

The separator for an electrochemical device according to the present disclosure includes a porous polymer substrate having a high porosity and a coating layer, so that the separator has a low resistance, and since the porous polymer substrate includes a polymer having a low melt index, the mechanical strength may be excellent.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a flowchart of a manufacturing method of a separator for an electrochemical device according to one embodiment of the present disclosure.

### DETAILED DESCRIPTION

Hereinafter, each configuration of the present disclosure will be described in more detail so that those skilled in the art to which the present disclosure pertains may readily practice it, but this is merely an example, and the scope of rights of the present disclosure is not limited by the following description.

In the present specification, the term “comprising” or “including” is used when listing materials, compositions, devices, and methods useful for the present disclosure, and is not limited to the listed examples.

In the present specification, the terms “about” and “substantially” are used in the sense of including the range of numerical values or degrees in consideration of inherent manufacturing and material tolerances, or values close thereto, and are used to prevent an infringer from improperly exploiting disclosure in which accurate or absolute numerical values are provided to assist in understanding the present disclosure.

In the present specification, when it is described that one element is “on” another element, unless expressly stated to the contrary, this does not exclude that another element may be disposed in between, and means that another element may additionally be disposed.

In the present specification, the “electrochemical device” may refer to a primary battery, a secondary battery, or a supercapacitor. For example, the electrochemical device may be a lithium ion secondary battery, and may be in a pouch type, cylindrical type, prismatic type, or coin type, but the specific shape is not limited thereto.

In the present specification, the “electrode” collectively refers to a positive electrode and a negative electrode, and may mean that an electrode active material is applied and dried on at least one surface of a conductive material without causing a chemical change in the electrochemical device. The type of the conductive material and the electrode active material is not limited so long as they are suitable for use in the electrochemical device.

In the present specification, the “separator” may refer to a functional separator in which a porous coating layer including inorganic material and a binder is formed on at least one surface of a porous polymer substrate such as a polyolefin substrate or a nonwoven fabric. In addition, the separator has a porous characteristic including a plurality of pores and serves as a porous ion-conducting barrier that blocks electrical contact between a negative electrode and a positive electrode in an electrochemical device while allowing ions to pass through.

In the present specification, the characteristic of having pores means that the object includes a plurality of pores and has an interconnected structure among the pores, such that a gaseous and/or liquid fluid is able to pass through the object from one side to the other side.

In the present specification, the “porous polymer substrate” may refer to a porous membrane having a plurality of pores, which electrically insulates a positive electrode and a negative electrode to prevent a short circuit. For example, when the electrochemical device is a lithium secondary battery, the porous polymer substrate may be an ion conductive barrier that allows lithium ions to pass through while blocking electrical contact between the positive electrode and the negative electrode. At least a portion of the pores may form a three-dimensional network communicating with the surface and interior of the porous polymer substrate, and fluid may pass through the porous polymer substrate through the pores.

In the present specification, “average particle diameter (D₅₀)” or “mean particle size (D₅₀)” refers to the diameter of a particle corresponding to the 50% point of a cumulative number-based particle size distribution of the particles being measured. The diameter may be measured using a laser diffraction method. For example, powder to be measured is dispersed in a dispersion medium and introduced into a commercially available laser diffraction particle size measurement device (e.g., Microtrac S3500) to measure the difference in diffraction pattern according to particle size when the particles pass through the laser beam, thereby calculating the particle size distribution. The particle diameter (D₅₀) is determined by calculating the particle diameter at the 50% point of the cumulative number-based distribution of particle diameters in the measuring device.

In the present specification, the “melt index (MI)” or “melt flow index” refers to a measure representing the fluidity of a polymer material or the ease of flow of a polymer melt, and means the flow rate when the polymer melt is extruded under specific temperature and pressure conditions. The melt index may be influenced by the molecular weight of the polymer, and when the molecular weight of the polymer is high, the melt index of the polymer may be low. For example, the melt index of the polymer may be measured at a temperature of 190° C. and a load of 21.6 kg in accordance with ASTM D1238.

In the present specification, the term “cubic shape” means that the particle has a cubic form, for example, a rectangular parallelepiped form. For example, in the case of boehmite, which is a type of inorganic particle, the shape of the particle may be amorphous, spherical, plate-like, or cubic, and among them, cubic-shaped boehmite may have the appearance of a three-dimensional rectangular parallelepiped as observed under a scanning electron microscope.

In the present specification, the term “porosity” means the ratio of the volume of pores to the total volume in a structure, uses vol % as the unit, and may be interchangeably used with terms such as porosity degree, pore ratio, or porosity rate. In the present disclosure, the measurement of porosity is not particularly limited, and for example, may be performed by a BET (Brunauer-Emmett-Teller) method using nitrogen gas, a mercury intrusion method (Hg porosimeter), or in accordance with ASTM D-2873. Alternatively, the true density of the separator may be calculated from the density (apparent density) of the separator, the composition ratio of the materials included in the separator, and the density of each component, and the porosity of the porous polymer, the coating layer, or the separator may be calculated from the difference between the apparent density and the true density.

In the present specification, the term “crystallinity” of a polymer means the proportion of the portion arranged in a crystalline state within the polymer or material relative to the whole, uses % as the unit, and may be interchangeably used with terms such as crystallinity degree or crystallinity property. In the present disclosure, the measurement of crystallinity is not particularly limited, and according to one embodiment of the present disclosure, for example, may be performed by an X-ray diffraction method (XRD), a differential scanning calorimetry (DSC), a Fourier-transform infrared spectroscopy (FT-IR), or a density measurement method and relevant ASTM or ISO standards. For example, the crystallinity may be measured by an X-ray diffraction method (XRD).

In the present specification, the term “machine direction (MD)” means the direction in which a polymer sheet is conveyed during a stretching process, and at the same time, the direction parallel to the direction in which the porous polymer substrate is conveyed in a manufacturing system of a separator for an electrochemical device, for example, a longitudinal direction. The term “transverse direction (TD)” means the direction perpendicular to the conveying direction of the polymer sheet, for example, a transverse direction. Accordingly, the MD direction and the TD direction are perpendicular to each other.

Among the components of an electrochemical device, the separator may include a polymer substrate having a porous structure located between the positive electrode and the negative electrode, and the separator isolates the positive electrode and the negative electrode to prevent or suppress electrical short-circuiting between the two electrodes, and also allows an electrolyte and ions to pass through. Although the separator itself does not participate in an electrochemical reaction, physical properties such as wettability to an electrolyte, porosity, and thermal shrinkage ratio may affect the performance and safety of the electrochemical device.

Therefore, in order to enhance the physical properties of such a separator, various methods have been attempted in which a coating layer is added to the porous polymer substrate and various materials are added to the coating layer to improve the physical properties of the coating layer. For example, in order to improve the mechanical strength of the separator, inorganic material may be added to the coating layer, or an inorganic material or a hydrate for improving the flame retardancy and heat resistance of the polymer substrate may be added to the coating layer.

In the coating layer, inorganic particles may be connected to other inorganic particles by a polymer binder to form an interstitial volume, and lithium ions may migrate through the interstitial volume. For example, the coating layer including a polymer binder and inorganic particles serves to prevent or suppress thermal shrinkage of the separator, and also assists in the migration of lithium ions through the separator.

Meanwhile, when the porous polymer substrate and the coating layer used in the separator for an electrochemical device have a low porosity, there is a problem in that the resistance of the separator for an electrochemical device increases and the performance of the electrochemical device including the separator may deteriorate. Accordingly, research has been conducted on methods of increasing the porosity of the porous polymer substrate and the coating layer to lower the resistance of the separator for an electrochemical device while increasing output. However, a separator for an electrochemical device including a porous polymer substrate having a high porosity has the disadvantage of poor mechanical strength and vulnerability to external pressure such as electrode expansion caused by a lamination process and cell operation. Therefore, an electrochemical device including a separator for an electrochemical device that is vulnerable to such external pressure has the problem of poor stability during long-term operation.

For example, a separator for an electrochemical device including a porous polymer substrate having a high porosity may have a low electrical resistance, but due to the high porosity, a mechanical strength such as the compressive strength may be poor. Therefore, a conventional separator for an electrochemical device including such a porous polymer substrate having a high porosity may have a problem in that the pores present in the porous polymer substrate are closed by pressure generated during a lamination process. As a result, in the separator for an electrochemical device that has undergone lamination, the porosity of the porous polymer substrate decreases, causing an increase in the resistance of the separator. In addition, during operation of the electrochemical device, an electrode included in the electrochemical device may expand and apply pressure to the separator for an electrochemical device, and such pressure may cause deformation of the separator for an electrochemical device, resulting in deterioration of stability of the electrochemical device.

In consideration of such points, the present disclosure provides a separator for an electrochemical device and a method for manufacturing the same, in which the separator includes a porous polymer substrate having a high porosity and a coating layer, thereby maintaining a low resistance of the separator while controlling the melt index of the polymer used in the substrate so that the separator also has an excellent mechanical strength.

Hereinafter, the present disclosure will be described in more detail.

According to an embodiment of the present disclosure, the separator for an electrochemical device includes a porous polymer substrate and a coating layer disposed on at least one surface of the porous polymer substrate and including inorganic particles, in which the porous polymer substrate has a porosity of about 50 vol % to 65 vol %, the porous polymer substrate includes a polymer having a melt index (MI) of about 0.0001 g/10 min to 0.01 g/10 min, and the coating layer has a porosity of about 50 vol % to 70 vol %.

The separator for an electrochemical device may include a coating layer including the inorganic particles disposed on one or both surfaces of the porous polymer substrate. The porosity of the porous polymer substrate is about 50 vol % or more and 65 vol % or less. For example, the porosity of the porous polymer substrate may be about 50 vol % or more, about 51 vol % or more, about 52 vol % or more, about 53 vol % or more, about 54 vol % or more, or about 55 vol % or more, and may also be about 65 vol % or less, about 64 vol % or less, about 63 vol % or less, about 62 vol % or less, about 61 vol % or less, about 60 vol % or less, about 59 vol % or less, about 58 vol % or less, about 57 vol % or less, about 56 vol % or less, or about 55 vol % or less. When the porosity of the porous polymer substrate satisfies the above range, a sufficient volume of pores is present in the porous polymer substrate, so that lithium ions may smoothly migrate through the pores, and as a result, the separator for an electrochemical device may maintain mechanical strength and compressive resistance at appropriate values while also maintaining a low resistance. Furthermore, due to the high porosity of the porous polymer substrate, the output of the electrochemical device including the separator for an electrochemical device may also be high.

The porous polymer substrate includes a polymer having a melt index of about 0.0001 g/10 min or more and 0.01 g/10 min or less. For example, the polymer may have a melt index of about 0.0001 g/10 min or more, about 0.0005 g/10 min or more, about 0.001 g/10 min or more, or about 0.005 g/10 min or more, and may also have a melt index of about 0.01 g/10 min or less, about 0.005 g/10 min or less, about 0.001 g/10 min or less, or about 0.0005 g/10 min or less. When the melt index of the polymer satisfies the above range, the polymer may have high weight average molecular weight and density, and accordingly, the porous polymer substrate including the polymer may have an excellent mechanical strength such as the compressive resistance.

The separator for an electrochemical device of the present disclosure includes a porous polymer substrate manufactured from a polymer having a low melt index, high density, and excellent mechanical strength, so that even when pressure is applied during a lamination process, the problem of pore closure within the substrate may be minimized and the rate of resistance increase of the separator may also be low. In addition, as described above, since the porous polymer substrate of the present disclosure has an excellent mechanical strength such as the compressive resistance, the problem of pore closure in the substrate during operation of the electrochemical device may also be minimized, and the electrochemical device including the separator for an electrochemical device has the advantage of high long-term operational stability. Furthermore, due to the high compressive resistance, the dielectric breakdown voltage of the separator may also be high. For example, although attempts have been made to improve compressive resistance of the substrate by manufacturing a porous polymer substrate using a polymer having a low melt index, there has been difficulty in maintaining high porosity of the substrate due to the low processability of the polymer. However, in the present disclosure, a method for manufacturing a porous polymer substrate described below achieves the production of a substrate having a porosity of about 50 vol % to 65 vol % while using a polymer having a low melt index. Therefore, the present disclosure achieves both the effect of improving compressive resistance of the substrate and the effect of reducing resistance of the separator due to high porosity, which have conventionally been in a trade-off relationship.

The porosity of the coating layer is about 40 vol % or more and 70 vol % or less. For example, the porosity of the coating layer may be about 40 vol % or more, about 45 vol % or more, about 50 vol % or more, about 55 vol % or more, or about 60 vol % or more, and may also be about 70 vol % or less, about 65 vol % or less, about 60 vol % or less, about 55 vol % or less, or about 50 vol % or less. When the porosity of the coating layer satisfies the above range, a sufficient volume of pores is present in the coating layer, so that lithium ions may smoothly migrate through the pores, and accordingly, the separator for an electrochemical device may maintain appropriate mechanical strength while having a low resistance. Furthermore, the electrochemical device including the separator for an electrochemical device may also have high output.

In summary, the separator for an electrochemical device of the present disclosure has both a porous polymer substrate and a coating layer with high porosity, so that the separator may have a low resistance and high output. In addition, the separator for an electrochemical device may also have a high mechanical strength such as the compressive resistance due to the porous polymer substrate including a polymer having a low melt index, thereby providing an excellent stability.

According to one embodiment of the present disclosure, the crystallinity of the polymer in the porous polymer substrate may be about 60% or more and 90% or less. For example, the crystallinity of the polymer may be about 60% or more, about 65% or more, about 70% or more, about 75% or more, or about 80% or more, and may also be about 90% or less, about 85% or less, about 80% or less, or about 75% or less. When the crystallinity of the polymer satisfies the above range, the porous polymer substrate has an excellent durability, so that the problem of pore closure within the substrate caused by a lamination process or expansion of an electrode may be minimized, thereby providing an excellent stability of the separator during operation of the electrochemical device and maintaining stable performance even during long-term operation.

According to one embodiment of the present disclosure, the polymer may have a weight average molecular weight of about 1,500,000 g/mol or more and 2,500,000 g/mol or less. For example, the polymer may have a weight average molecular weight of about 1,500,000 g/mol or more, about 1,800,000 g/mol or more, or about 2,000,000 g/mol or more, and may also have a weight average molecular weight of about 2,500,000 g/mol or less, about 2,000,000 g/mol or less, or about 1,800,000 g/mol or less. When the weight average molecular weight of the polymer satisfies the above range, the fluidity of the polymer is low, so that the melt index of the polymer may satisfy the above-described range. Therefore, the porous polymer substrate including the polymer may have an excellent mechanical strength such as the compressive resistance, and the separator for an electrochemical device including the porous polymer substrate may also have an excellent stability.

According to one embodiment of the present disclosure, the polymer may be one or more selected from polyethylene, polypropylene, polybutylene, polyvinyl chloride, polyethylene terephthalate, polycycloolefin, polyethersulfone, polyamide, polyimide, polyimideamide, nylon, and polytetrafluoroethylene, and for example, the polymer may be polyethylene. The listed polymers are physically and chemically stable with respect to an organic solvent electrolyte, and thus, a porous polymer substrate including the polymers has the advantage of being suitable for use as a separator for an electrochemical device. For example, when the porous polymer substrate includes polyethylene, the separator for an electrochemical device may have an excellent stability due to the high chemical and electrochemical stability of the polyethylene. Furthermore, the polyethylene has an excellent ionic conductivity, so that the separator for an electrochemical device including polyethylene may have a low resistance.

According to one embodiment of the present disclosure, the inorganic particles may have a cubic shape. In the case of a conventional coating layer including amorphous inorganic particles, the porosity of the coating layer may be low as the inorganic particles are densely packed in the coating layer. In contrast, when the inorganic particles have a cubic shape, sufficient spacing between the inorganic particles may be ensured due to the unique three-dimensional structure of the cubic shape, and accordingly, the porosity of the coating layer may satisfy the above range. In addition, when the inorganic particles have a cubic shape, unlike in the case of using amorphous inorganic particles, it is easy to determine physical properties such as particle volume or specific surface area, thereby facilitating the control of the porosity of the coating layer by adjusting the volume or content of the inorganic particles.

According to one embodiment of the present disclosure, the inorganic particles may have an average particle diameter (D50) of about 200 nm or more and 1 μm or less. For example, the inorganic particles may have an average particle diameter of about 200 nm or more, about 300 nm or more, about 400 nm or more, or about 500 nm or more, and may also have an average particle diameter of about 1 μm or less, about 900 nm or less, about 800 nm or less, about 700 nm or less, about 600 nm or less, or about 500 nm or less. When the average particle diameter of the inorganic particles satisfies the above range, sufficient spacing between the packed inorganic particles in the coating layer may be present, and accordingly, the porosity of the coating layer may be high as described above. Furthermore, when the average particle diameter of the inorganic particles satisfies the above range, the inorganic particles may have an excellent dispersibility in a coating layer slurry prepared for manufacturing the coating layer, and the thickness of the coating layer manufactured therefrom may also be thin.

According to one embodiment of the present disclosure, the inorganic particles included in the coating layer may be one or more selected from boehmite (γ-AlO(OH)), alumina (Al₂O₃), BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al(OH)₃, TiO₂, aluminum peroxide, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅), and for example, the inorganic particles may be boehmite. The inorganic particles may not undergo oxidation and/or reduction reactions within the operating voltage range of the electrochemical device (for example, 0 V to 5 V based on Li/Li+). For example, when the coating layer includes boehmite as the inorganic particles, the thermal shrinkage problem of the separator for an electrochemical device may be effectively improved due to the high heat resistance of the boehmite. In addition, due to the low density of the boehmite, the coating layer and the separator may be advantageously lightened. Furthermore, as described above, when the coating layer includes cubic boehmite, the thermal shrinkage problem of the separator may be effectively improved, and at the same time, the resistance of the separator may also be low due to the high porosity of the coating layer.

According to one embodiment of the present disclosure, the content of the inorganic particles may be about 90 parts by weight or more based on 100 parts by weight of the total weight of the coating layer. For example, the content of the inorganic particles may be about 90 parts by weight or more, about 91 parts by weight or more, about 92 parts by weight or more, about 93 parts by weight or more, or about 94 parts by weight or more, and may also be about 99 parts by weight or less, about 98 parts by weight or less, about 97 parts by weight or less, about 96 parts by weight or less, or about 95 parts by weight or less, based on 100 parts by weight of the total weight of the coating layer. When the content of the inorganic particles in the coating layer satisfies the above range, the inorganic particles having an excellent heat resistance are sufficiently included in the coating layer, and therefore thermal shrinkage may be minimized in the separator for an electrochemical device in which the coating layer is provided on at least one surface of the porous polymer substrate.

According to one embodiment of the present disclosure, the coating layer further includes a binder, and the content of the binder may be about 1 part by weight or more and 10 parts by weight or less based on 100 parts by weight of the total weight of the coating layer. For example, the content of the binder may be about 1 part by weight or more, about 2 parts by weight or more, about 3 parts by weight or more, about 4 parts by weight or more, or about 5 parts by weight or more, and may also be about 10 parts by weight or less, about 9 parts by weight or less, about 8 parts by weight or less, about 7 parts by weight or less, about 6 parts by weight or less, or about 5 parts by weight or less, based on 100 parts by weight of the total weight of the coating layer. When the coating layer includes the binder in the above content range, the inorganic particles may be connected to each other by the binder to effectively increase the interstitial volume, and as a result, the porosity of the coating layer may be high. In addition, since the inorganic particles are fixed by the binder, the porosity of the coating layer may be stably maintained even when the electrochemical device is operated for a long time. Furthermore, the adhesion between the coating layer and an electrode may also be improved by the binder.

According to one embodiment of the present disclosure, the binder may be one or more selected from polyacrylic acid, polyacrylamide, polyvinylidene fluoride-co-hexafluoropropylene, polyvinylidene fluoride-co-trichloroethylene, polymethylmethacrylate, polyacrylonitrile, polyvinylpyrrolidone, polyvinylacetate, poly (ethylene-co-vinyl acetate), polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrene butadiene copolymer, polyimide, and styrene-butadiene rubber.

According to one embodiment of the present disclosure, the thickness of the porous polymer substrate may be about 4 μm or more and 20 μm or less. For example, the thickness of the porous polymer substrate may be about 4 μm or more, about 6 μm or more, about 8 μm or more, about 10 μm or more, or about 12 μm or more, and may also be about 20 μm or less, about 18 μm or less, about 16 μm or less, about 14 μm or less, about 12 μm or less, about 10 μm or less, about 8 μm or less, about 6 μm or less, or about 5 μm or less. When the thickness of the porous polymer substrate satisfies the above range, the thickness of the separator for an electrochemical device including the porous polymer substrate does not excessively increase, so that the resistance of the separator may be low. In addition, since the thickness of the porous polymer substrate is not excessively thin, the separator may also have an excellent mechanical strength. Furthermore, the separator for an electrochemical device including the porous polymer substrate having the above thickness range electrically insulates the positive electrode and the negative electrode while minimizing the volume of the electrochemical device, thereby increasing the amount of active material included in the electrochemical device.

According to one embodiment of the present disclosure, the thickness of the coating layer may be about 0.5 μm or more and 4 μm or less. For example, the thickness of the coating layer may be about 0.5 μm or more, about 1 μm or more, about 1.5 μm or more, about 2 μm or more, or about 2.5 μm or more, and may also be about 4 μm or less, about 3.5 μm or less, about 3 μm or less, about 2.5 μm or less, about 2 μm or less, about 1.5 μm or less, or about 1 μm or less. When the thickness of the coating layer satisfies the above range, the separator for an electrochemical device including the coating layer may effectively improve insulation and thermal stability of the separator while also reducing the overall thickness of the separator. Therefore, the amount of active material included in the electrochemical device may relatively increase, and accordingly, the energy density of the electrochemical device may also increase.

According to one embodiment of the present disclosure, the thickness of the separator for an electrochemical device may be about 7 μm or more and 25 μm or less. For example, the thickness of the separator for an electrochemical device may be about 7 μm or more, about 9 μm or more, about 11 μm or more, about 13 μm or more, or about 15 μm or more, and may also be about 25 μm or less, about 23 μm or less, about 21 μm or less, about 19 μm or less, about 17 μm or less, about 15 μm or less, or about 13 μm or less. When the thickness of the separator for an electrochemical device satisfies the above range, the separator electrically insulates the positive electrode and the negative electrode, and at the same time, the volume of the separator for an electrochemical device may also be minimized. Therefore, the amount of active material included in the electrochemical device may relatively increase, and accordingly the energy density of the electrochemical device may also increase.

According to one embodiment of the present disclosure, the porous polymer substrate may include pores having an average diameter of about 0.01 μm or more and 1 μm or less. For example, the size of the pores included in the porous polymer substrate may be about 0.01 μm or more, about 0.02 μm or more, about 0.03 μm or more, about 0.04 μm or more, about 0.05 μm or more, or about 0.1 μm or more, and may also be about 1 μm or less, about 0.5 μm or less, about 0.1 μm or less, about 0.09 μm or less, about 0.08 μm or less, about 0.07 μm or less, or about 0.06 μm or less. In one embodiment, the size of the pores may be about 0.02 μm or more and 0.06 μm or less. When the pore size of the porous polymer substrate is adjusted within the above-mentioned range, the permeability and ionic conductivity of the entire prepared separator may be controlled.

The porous polymer substrate may have a permeability of about 10 s/100 cc or more and 100 s/100 cc or less. For example, the permeability of the porous polymer substrate may be about 10 s/100 cc or more, about 20 s/100 cc or more, about 30 s/100 cc or more, about 40 s/100 cc or more, or about 50 s/100 cc or more, and may also be about 100 s/100 cc or less, about 90 s/100 cc or less, about 80 s/100 cc or less, or about 70 s/100 cc or less. For example, the permeability of the porous polymer substrate may be about 50 s/100 cc or more and 70 s/100 cc or less. When the permeability of the porous polymer substrate is within the above range, the air permeability of the manufactured separator may be provided within a range suitable for ensuring output and cycle characteristics of the electrochemical device. The permeability (s/100 cc) refers to the time (seconds) required for 100 cc of air to pass through a predetermined area of the porous polymer substrate or separator under a constant pressure. The permeability may be measured using a Gurley densometer in accordance with ASTM D 726-58, ASTM D726-94, or JIS-P8117. For example, using the 4110N equipment of Gurley, the time for 100 cc of air to pass through a sample of 1 square inch (or 6.54 cm²) may be measured under air pressure of 0.304 kPa or water pressure of 1.215 kN/m². For example, using the EG01-55-1MR equipment of Asahi Seiko, the time for 100 cc of air to pass through a sample of 1 square inch may be measured at room temperature under a constant water pressure of 4.8 inches.

The present disclosure provides a method for manufacturing a separator for an electrochemical device.

According to one embodiment of the present disclosure, the method for manufacturing a separator for an electrochemical device may be a method of manufacturing the separator for an electrochemical device, and accordingly, overlapping description with the description of the separator for an electrochemical device will be omitted.

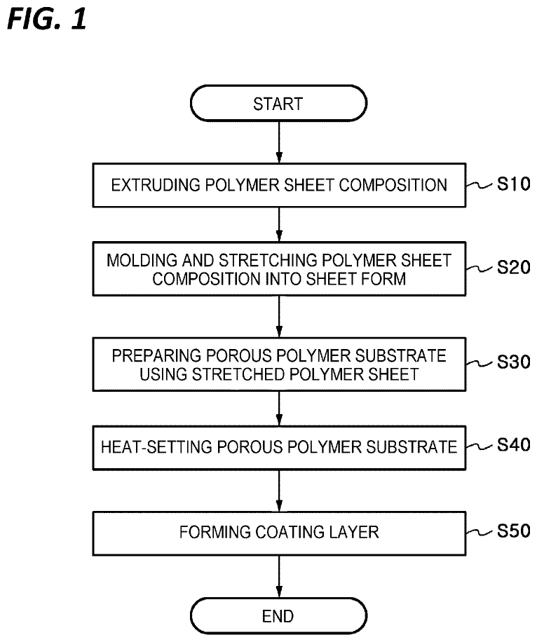

Referring to FIG. 1, according to one embodiment of the present disclosure, the method for manufacturing a separator for an electrochemical device includes: (S10) a step of extruding a polymer sheet composition including a polymer and a diluent; (S20) a step of molding and stretching the polymer sheet composition extruded in step S10 into a sheet form; (S30) a step of extracting the diluent from the stretched polymer sheet in step S20 to manufacture a porous polymer substrate; (S40) a step of heat-setting the porous polymer substrate; and (S50) a step of forming a coating layer including inorganic particles on at least one surface of the porous polymer substrate. The polymer has a melt index of about 0.0001 g/10 min or more and 0.01 g/10 min or less, and the content of the diluent is about 70 parts by weight or more and 90 parts by weight or less based on 100 parts by weight of the total polymer sheet composition.

The method for manufacturing a separator for an electrochemical device includes a method for manufacturing a porous polymer substrate using a polymer having a low melt index and an excellent mechanical strength, and thus, as described above, the separator may have an excellent compressive resistance while also having a low resistance.

According to one embodiment of the present disclosure, step S10 may be a step of inputting a polymer and a diluent into an extruder, melt-kneading them, and extruding the mixture to prepare a polymer sheet-forming composition in which the diluent is dispersed between the polymers. Step S20 may be a step of stretching the polymer sheet formed in a sheet form from the polymer sheet composition extruded in step S10, and the diluent may be dispersed between the polymers in the polymer sheet. The diluent may be an aliphatic hydrocarbon-based solvent such as liquid paraffin, paraffin oil, mineral oil, or paraffin wax; a vegetable oil such as soybean oil, sunflower oil, rapeseed oil, palm oil, coconut oil, corn oil, grape seed oil, or cottonseed oil; or a plasticizer such as dialkyl phthalate.

The method for manufacturing a separator for an electrochemical device is such that the content of the diluent is about 70 parts by weight or more and 90 parts by weight or less, based on 100 parts by weight of the total polymer sheet composition. The total weight of the polymer sheet composition means the combined weight of the polymer and the diluent. For example, the content of the diluent may be about 70 parts by weight or more, about 75 parts by weight or more, or about 80 parts by weight or more, and may also be about 90 parts by weight or less, about 85 parts by weight or less, or about 80 parts by weight or less, based on 100 parts by weight of the total polymer sheet composition. When the content of the diluent satisfies the above range, a sufficient amount of the diluent such as paraffin oil may be included in the polymer sheet composition, so that the porous polymer substrate obtained through step S30 in which the diluent is removed may have high porosity. Therefore, in the present disclosure, even though the polymer having a low melt index and poor processability is used, it is possible to manufacture a porous polymer substrate satisfying high porosity compared to the prior art, and accordingly the resistance of the separator may be low. When the content of the diluent satisfies the above range, the porosity of the finally manufactured porous polymer substrate may be maintained within an appropriate range, and accordingly the resistance of the separator may also be maintained at a low level within an appropriate range. In addition, the durability of the porous polymer substrate may be maintained so that the porous polymer substrate may be stably manufactured.

According to one embodiment of the present disclosure, step S20 may be a step of stretching the polymer sheet in a machine direction (MD) and a transverse direction (TD). The stretching ratio in the MD direction may be about 6 or more and 10 or less, and the stretching ratio in the TD direction may be about 8 or more and 20 or less. For example, the stretching ratio in the MD direction may be about 6 or more, about 7 or more, or about 8 or more, and may also be about 10 or less, about 9 or less, or about 8 or less. In addition, the stretching ratio in the TD direction may be about 8 or more, about 9 or more, about 10 or more, about 11 or more, or about 12 or more, and may also be about 20 or less, about 18 or less, about 16 or less, about 14 or less, or about 12 or less. When the stretching ratios in the MD direction and the TD direction satisfy the above ranges in addition to the content of the diluent in the polymer sheet composition, the porous polymer substrate may have high porosity as described above even though the polymer having a low melt index and poor processability is used.

According to one embodiment of the present disclosure, the stretching temperature in the MD direction and the TD direction of step S20 may be about 100° C. or more and 120° C. or less. For example, the stretching temperature in the MD direction and the TD direction of step S20 may be about 100° C. or more, about 105° C. or more, or about 110° C. or more, and may also be about 120° C. or less, about 115° C. or less, or about 110° C. or less. When the stretching temperature satisfies the above range, the polymer sheet may be effectively stretched, so that the porosity of the substrate may be improved, and at the same time, the problem of damage to the substrate due to high temperature may be prevented. Therefore, it may be easy to manufacture a porous polymer substrate having an excellent durability and porosity.

Step S30 may be a step of manufacturing a porous polymer substrate by extracting the diluent from the polymer sheet stretched in step S20. For example, step S30 may include extracting the diluent from the polymer sheet using a solvent and then drying the polymer sheet. The solvent usable for extraction of the diluent may be any solvent used for extracting the diluent in the relevant technical field regardless of the type thereof. For example, the solvent may be methyl ethyl ketone, methylene chloride, or hexane, which have high extraction efficiency and fast drying. In addition, the extraction of the diluent may be performed by immersion, solvent spray, ultrasonic methods, or a combination thereof.

Step S40 may be a step of heat-setting the porous polymer substrate, and through the heat-setting process, residual stress in the polymer sheet that tends to shrink after stretching may be removed, and the porous polymer substrate subjected to the heat-setting may have low thermal shrinkage when applied to a separator for an electrochemical device.

According to one embodiment of the present disclosure, the heat-setting temperature of step S40 may be about 129° C. or more and 135° C. or less. For example, the heat-setting temperature of step S40 may be about 129° C. or more, about 130° C. or more, about 131° C. or more, or about 132° C. or more, and may also be about 135° C. or less, about 134° C. or less, or about 133° C. or less. When the heat-setting temperature satisfies the above range, only residual stress may be effectively removed without thermal damage to the porous polymer substrate, so that a porous polymer substrate having an excellent heat resistance and high porosity may be manufactured. In summary, as the content of the diluent, the stretching ratios in the MD and TD directions, and the heat-setting temperature satisfy the above ranges, the porosity of the porous polymer substrate may be easily controlled within the above-described range even though the polymer having a low melt index and poor processability is used. As a result, the separator for an electrochemical device including the porous polymer substrate may have a relatively low resistance and excellent compressive resistance.

Step S50 may be a step of forming a coating layer including inorganic particles on at least one surface of the porous polymer substrate, and the coating layer may improve the heat resistance of the separator. Step S50 may be a step of forming the coating layer on one or both surfaces of the porous polymer substrate using a coating layer-forming composition including inorganic particles. The method of forming the coating layer is not particularly limited to a specific method, and conventional methods known in the art may be used. For example, various methods such as dip coating, die coating, roll coating, comma coating, bar coating, or a combination thereof may be used.

According to one embodiment of the present disclosure, the coating layer-forming composition may include inorganic particles having a cubic shape, and the average particle diameter (D₅₀) of the inorganic particles may be 200 nm or more and 1 μm or less. When the coating layer is formed on at least one surface of the porous polymer substrate using the coating layer-forming composition including the inorganic particles, a separator in which the coating layer having porosity within the above-described range is disposed on at least one surface of the substrate may be easily manufactured, and accordingly, both resistance and heat resistance of the separator may be improved.

The present disclosure provides an electrochemical device.

According to one embodiment of the present disclosure, the electrochemical device includes a positive electrode, a negative electrode, and the separator for an electrochemical device, in which the separator is interposed between the positive electrode and the negative electrode. The electrochemical device may further include an electrolyte, a battery case, and a cap assembly. In the electrochemical device according to one embodiment of the present disclosure, overlapping description with the description of the separator for an electrochemical device will be omitted.

The electrochemical device is a device that converts chemical energy into electrical energy by an electrochemical reaction, and is a concept encompassing both a primary battery and a secondary battery. The secondary battery is chargeable and dischargeable, and refers to batteries such as a lithium secondary battery, a nickel-cadmium battery, and a nickel-hydrogen battery. The lithium secondary battery uses lithium ions as ionic conductors, and examples thereof include a non-aqueous electrolyte secondary battery including a liquid electrolyte, an all-solid-state battery including a solid electrolyte, a lithium polymer battery including a gel polymer electrolyte, and a lithium metal battery using lithium metal as a negative electrode, but are not limited thereto.

Since the electrochemical device includes the above-described separator for an electrochemical device of the present disclosure, the electrochemical device may be stably operated even when an electrode expands during long-term operation, by virtue of the excellent compressive resistance of the separator for an electrochemical device. In addition, due to the high porosity of the separator for an electrochemical device, lithium ions can smoothly migrate through the separator for an electrochemical device, thereby providing an excellent output. Furthermore, since the separator for an electrochemical device has an excellent compressive resistance and is capable of maintaining high porosity even during long-term operation, lithium may smoothly migrate during charging and discharging of the electrochemical device, so that the electrochemical device may maintain a sufficient amount of capacity even when charging and discharging are repeatedly performed many times.

According to one embodiment of the present disclosure, the positive electrode may include a positive electrode current collector and a positive electrode active material layer provided on at least one surface of the current collector and including a positive electrode active material, a conductive material, and a binder resin. The positive electrode active material may include a layered compound such as lithium manganese composite oxide (LiMn₂O₄, LiMnO₂, etc.), lithium cobalt oxide (LiCoO₂), or lithium nickel oxide (LiNiO₂), or a compound substituted with one or more transition metals; a lithium manganese oxide such as Li₁₊ₓMn₂₋ₓO₄ (where x is 0 to 0.33), LiMnO₃, LiMn₂O₃, or LiMnO₂; a lithium copper oxide (Li₂CuO₂); a vanadium oxide such as LiV₃O₈, LiV₃O₄, V₂O₅, or Cu₂V₂O₇; a nickel-site lithium nickel oxide represented by the formula LiNi₁₋ₓMₓO₂ (where M is Co, Mn, Al, Cu, Fe, Mg, B, or Ga, and x is 0.01 to 0.3); a lithium manganese composite oxide represented by the formula LiMn₁₋ₓMₓO₂ (where M is Co, Ni, Fe, Cr, Zn, or Ta, and x is 0.01 to 0.1) or Li₂Mn₃Mo₈ (where M is Fe, Co, Ni, Cu, or Zn); LiMn₂O₄ in which a portion of Li is substituted with an alkaline earth metal ion; a disulfide compound; Fe₂(MoO₄)₃, either alone or in a mixture of two or more thereof.

According to one embodiment of the present disclosure, the negative electrode may include a negative electrode current collector and a negative electrode active material layer provided on at least one surface of the current collector and including a negative electrode active material, a conductive material, and a binder resin. The negative electrode may include, as the negative electrode active material, carbon such as lithium metal oxide, non-graphitizable carbon, or graphitic carbon; a metal composite oxide such as LixFe₂O₃ (0≤x≤1), LiₓWO₂ (0≤x≤1), or SnₓMe₁₋ₓMe′_{y}O_{z} (where Me is Mn, Fe, Pb, Ge; Me′ is Al, B, P, Si, a Group 1, 2, or 3 elements of the periodic table, or a halogen; 0<x≤1; 1≤y≤3; 1≤z≤8); lithium metal; a lithium alloy; a silicon-based alloy; a tin-based alloy; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer such as polyacetylene; a Li—Co—Ni based material; or a titanium oxide, alone or in a mixture of two or more thereof.

According to one embodiment of the present disclosure, the conductive material may be, for example, one or more selected from graphite, carbon black, carbon fiber, metal fiber, metal powder, conductive whisker, conductive metal oxide, activated carbon, and polyphenylene derivative, or a mixture of two or more thereof. For example, the conductive material may be one or a mixture of two or more selected from natural graphite, artificial graphite, Super P, acetylene black, Ketjen black, channel black, furnace black, lamp black, thermal black, Denka black, aluminum powder, nickel powder, zinc oxide, potassium titanate, and titanium oxide.

According to one embodiment of the present disclosure, the current collector is not particularly limited as long as it has high conductivity without causing a chemical change in the battery, and examples thereof include stainless steel, copper, aluminum, nickel, titanium, baked carbon, or a surface-treated material obtained by treating the surface of aluminum or stainless steel with carbon, nickel, titanium, and silver.

According to one embodiment of the present disclosure, the binder resin may be a polymer conventionally used for an electrode in the art. Non-limiting examples of the binder resin include polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan, and carboxyl methyl cellulose, but are not limited thereto.

According to one embodiment of the present disclosure, a positive electrode slurry for preparing the positive electrode active material layer may include a dispersant, and the dispersant may be a pyrrolidone-based compound. For example, the dispersant may be N-methylpyrrolidone (ADC-01, LG Chem).

According to one embodiment of the present disclosure, the electrochemical device may further include an electrolyte, and the electrolyte may be a salt having a structure such as A⁺B⁻, in which A⁺ may include an alkali metal cation such as Li⁺, Na⁺, or K⁺, or an ion composed of a combination thereof. In addition, B⁻ may include an anion such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, or C(CF₂SO₂)₃⁻, or an ion composed of a combination thereof, and the salt may be dissolved or dissociated in an organic solvent such as propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), γ-butyrolactone, or a mixture thereof, but is not limited thereto.

According to one embodiment of the present disclosure, a battery including the electrochemical device as a unit cell, a battery module including the battery, a battery pack including the battery module, and a device including the battery pack as a power source may be provided. Examples of the device may include a power tool driven by an electric motor; an electric vehicle including an electric vehicle (EV), a hybrid electric vehicle (HEV), or a plug-in hybrid electric vehicle (PHEV); an electric two-wheeled vehicle including an electric bicycle (E-bike) or an electric scooter (E-scooter); an electric golf cart; or a power storage system, but are not limited thereto.

Hereinafter, embodiments will be described in detail to explain the present disclosure. However, the embodiments according to the present disclosure may be modified in various other forms, and the scope of the present disclosure should not be construed as being limited to the embodiments described below. The embodiments of the present specification are provided to more fully explain the present disclosure to those of ordinary skill in the art.

### EXAMPLES AND COMPARATIVE EXAMPLES

### Preparation of Separator for Electrochemical Device

### Example 1

A polymer sheet composition including polyethylene (weight average molecular weight of 2,000,000 g/mol, melt index of 0.001 g/10 min) as a polymer and liquid paraffin as a diluent at a weight ratio of 20:80 was introduced into an extruder (Korea EM, φ32 twin-screw extruder, L/D=56) and melt-extruded to obtain an extruded polymer sheet composition. Subsequently, the extruded polymer sheet composition was passed through a T-die and a polymer sheet in the form of a sheet was prepared using a cooling casting apparatus.

Subsequently, the polymer sheet was stretched under the conditions of an MD stretching ratio of 8, a TD stretching ratio of 12, and a stretching temperature of 110° C. using a tenter-type sequential stretching machine. Then, liquid paraffin was removed from the stretched polymer sheet using methylene chloride to prepare a porous polymer substrate having pores. A coating solution for heat-setting (thermal initiator: dicumyl peroxide, 10 wt %; flame retardant: diphenyl (vinyl) phosphine oxide, 15 wt %; solvent: ethanol) was applied on one surface of the polymer substrate, and the polymer sheet was heat-set at 133° C. to prepare a final porous polymer substrate having a thickness of about 10 μm and a porosity of 55 vol %.

Boehmite powder in a cubic form having a particle diameter (D50) of 500 nm was prepared as inorganic particles. Polyacrylic acid (K-702, Lubrizol) was prepared as a binder, and sodium carboxymethyl cellulose (CMC-Na, SG-L02, GL Chem) was prepared as a dispersant. The prepared inorganic particles, binder, and dispersant were added to water at a weight ratio of 95:3:2, and the inorganic particles were crushed and dispersed to prepare a coating layer slurry.

The coating layer slurry was applied to both surfaces of the porous polymer substrate by a bar-coating method using a doctor blade, and the coated layer was dried with air at 50° C. using a heat gun to form coating layers on both surfaces of the porous polymer substrate. At this time, the porosity of each coating layer was 50 vol %, and the thickness of each coating layer was 2 μm. The thickness of the finally prepared separator was 14 μm.

### Example 2

A separator for an electrochemical device was prepared in the same manner as in Example 1, except that polyethylene resin (weight average molecular weight of 1,800,000 g/mol, melt index of 0.005 g/10 min) was used to prepare a porous polymer substrate (thickness of about 10 μm, porosity of 55 vol %).

### Example 3

A separator for an electrochemical device was prepared in the same manner as in Example 1, except that polyethylene resin (weight average molecular weight of 2,000,000 g/mol, melt index of 0.001 g/10 min) was used to prepare a porous polymer substrate (thickness of about 10 μm, porosity of 60 vol %).

### Example 4

A separator for an electrochemical device was prepared in the same manner as in Example 1, except that the porosity of each coating layer was 60 vol %.

### Comparative Example 1

A separator for an electrochemical device was prepared in the same manner as in Example 1, except that polyethylene resin (weight average molecular weight of 1,500,000 g/mol, melt index of 0.02 g/10 min) was used to prepare a porous polymer substrate (thickness of about 10 μm, porosity of 55 vol %).

### Comparative Example 2

After preparing a porous polymer substrate in the same manner as in Comparative Example 1, amorphous alumina powder (particle diameter (D₅₀) of 500 nm) was prepared as inorganic particles. Polyacrylic acid (K-702, Lubrizol) was prepared as a binder, and sodium carboxymethyl cellulose (CMC-Na, SG-L02, GL Chem) was prepared as a dispersant. The prepared inorganic particles, binder, and dispersant were added to water at a weight ratio of 95:3:2, and the inorganic particles were crushed and dispersed to prepare a coating layer slurry.

The coating layer slurry was applied to both surfaces of the porous polymer substrate by a bar-coating method using a doctor blade, and the coated layer was dried with air at 50° C. using a heat gun to form coating layers on both surfaces of the porous polymer substrate. At this time, the porosity of each coating layer was 35 vol %, and the thickness of each coating layer was 2 μm. The thickness of the finally prepared separator was 14 μm.

### Comparative Example 3

A separator for an electrochemical device was prepared in the same manner as in Example 1, except that polyethylene resin (weight average molecular weight of 1,000,000 g/mol, melt index of 0.1 g/10 min) was used to prepare a porous polymer substrate (thickness of about 10 μm, porosity of 40 vol %).

### Comparative Example 4

A separator for an electrochemical device was prepared in the same manner as in Example 1, except that the porous polymer substrate was prepared by introducing polyethylene and liquid paraffin into the extruder at a weight ratio of 40:60 in preparing the polymer sheet composition.

### Experimental Example

### (1) Measurement of Single-Sheet Resistance of Separator

Coin cells were fabricated by interposing the separators for an electrochemical device of Examples and Comparative Examples described above between SUS, respectively. An electrolyte including 1 M LiPF₆ and a mixture of ethylene carbonate and ethyl methyl carbonate at a volume ratio of 1:2 was injected into the coin cells. To measure the resistance of the coin cells, BioLogic Science Instrument VMP3 was used, and the resistance was measured from the results of electrochemical impedance spectroscopy under the conditions of amplitude of 10 mV and scan range of 0.1 Hz to 1 MHz at 25° C. The results are shown in Tables 1 and 2 below.

TABLE 1

| Parameter | | Example 1 | Example 2 | Example 3 | Example 4 |
|---|---|---|---|---|---|
| Porous | Melt index (g/10 min) | 0.001 | 0.005 | 0.001 | 0.001 |
| polymer | Polymer crystallinity (%) | 83 | 80 | 75 | 83 |
| substrate | Weight average molecular | 2,000,000 | 1,800,000 | 2,000,000 | 2,000,000 |
| | weight (g/mol) | | | | |
| | Porosity (vol %) | 55 | 55 | 60 | 55 |
| | Thickness (μm) | 10 | 10 | 10 | 10 |
| Coating | Inorganic particles | Cubic | Cubic | Cubic | Cubic |
| layer | | boehmite | boehmite | boehmite | boehmite |
| | Particle size (nm) | 500 | 500 | 500 | 500 |
| | Porosity (vol %) | 50 | 50 | 50 | 60 |
| | Cross-sectional thickness | 2 | 2 | 2 | 2 |
| | (μm) | | | | |

| | | | | |
|---|---|---|---|---|
| Separator thickness (μm) | 14 | 14 | 14 | 14 |
| Electrical resistance (Ω) | 0.4 | 0.4 | 0.3 | 0.3 |

TABLE 2

| | | Comparative | Comparative | Comparative | Comparative |
|---|---|---|---|---|---|
| Parameter | | Example 1 | Example 2 | Example 3 | Example 4 |
| Porous | Melt index (g/10 min) | 0.02 | 0.02 | 0.1 | 0.001 |
| polymer | Polymer crystallinity (%) | 70 | 70 | 55 | 80 |
| substrate | Weight average molecular | 1,500,000 | 1,500,000 | 1,000,000 | 2,000,000 |
| | weight (g/mol) | | | | |
| | Porosity (vol %) | 55 | 55 | 40 | 40 |
| | Thickness (μm) | 10 | 10 | 10 | 10 |
| Coating | Inorganic particles | Cubic | Amorphous | Cubic | Cubic |
| layer | | boehmite | alumina | boehmite | boehmite |
| | Particle size (nm) | 500 | 500 | 500 | 500 |
| | Porosity (vol %) | 50 | 35 | 50 | 50 |
| | Cross-sectional thickness | 2 | 2 | 2 | 2 |
| | (μm) | | | | |

| | | | | |
|---|---|---|---|---|
| Separator thickness (μm) | 14 | 14 | 14 | 14 |
| Electrical resistance (Ω) | 0.5 | 0.8 | 0.7 | 0.8 |

As shown in Tables 1 and 2, the separators for an electrochemical device of the Examples had high porosity in both the porous polymer substrate and the coating layer, and thus, it was confirmed that the resistance of the separators was lower than that of Comparative Examples. For example, unlike the separators of Examples in which the coating layer included cubic boehmite, the separator of Comparative Example 2 included amorphous alumina in the coating layer, so that the porosity of the coating layer was low, and therefore, even though the porosity of the porous polymer substrate was high, it was confirmed that the resistance of the separator was high. In addition, although the separator of Comparative Example 3 had high porosity in the coating layer, the porosity of the porous polymer substrate was low at 40 vol %, and therefore, it was confirmed that the resistance of the separator was as high as that of Comparative Example 2. Furthermore, although a polymer having a low melt index was used, in Comparative Example 4, in which the content of the diluent was introduced at 60 wt % in preparing the polymer sheet composition, unlike the preparation method of the separator for an electrochemical device of the present disclosure, the porosity of the substrate was low at 40 vol %, and therefore, it was confirmed that the resistance of the separator was high.

### (2) Evaluation of Compressive Resistance of Separator

### Measurement of Thickness and Resistance Change Rate after Lamination

For the separators for an electrochemical device of the above Examples and Comparative Examples, lamination was performed by stacking in the order of Haze PET/separator/Haze PET under the conditions of 60° C./6.5 MPa/1 sec using a hot press apparatus. The thickness of the separator after lamination was measured, and the resistance was measured in the same manner as in the method of measuring the single-sheet resistance of the separator, and the thickness reduction rate and the resistance increase rate before and after lamination were evaluated and shown in Table 3.

TABLE 3

| | | | | | Comp. | Comp. | Comp. | Comp. |
|---|---|---|---|---|---|---|---|---|
| Parameter | Ex. 1 | Ex. 2 | Ex. 3 | Ex. 4 | Ex. 1 | Ex. 2 | Ex. 3 | Ex. 4 |
| Thickness | 3 | 5 | 5 | 5 | 10 | 15 | 20 | 5 |
| reduction | | | | | | | | |
| rate (%) | | | | | | | | |
| Resistance | 5 | 7 | 7 | 7 | 10 | 15 | 25 | 5 |
| increase | | | | | | | | |
| rate (%) | | | | | | | | |

As shown in Table 3, since the separators for an electrochemical device of the Examples included a polymer having a low melt index in the porous polymer substrate, the mechanical strength of the separators was excellent, and therefore, it was confirmed that deformation such as thickness reduction was small even when pressure was applied to the separators by lamination. Accordingly, it was confirmed that the separators for an electrochemical device of Examples retained pores in an intact form even after lamination, and the porous polymer substrate maintained high porosity, so that the resistance increase rate was significantly lower than that of Comparative Examples. In contrast, since the separators for an electrochemical device of Comparative Examples included a polymer having a high melt index in the porous polymer substrate, it was confirmed that the thickness was significantly reduced by lamination, and consequently, the pores were closed and the resistance was significantly increased.

### Preparation of Electrochemical Device

Electrochemical devices were prepared using the separators for an electrochemical device of Examples and Comparative Examples, respectively.

### 1) Preparation of Positive Electrode

A slurry for a positive electrode active material layer having a concentration of 50 wt % excluding water was prepared by mixing a positive electrode active material (LiNi_{0.8}Mn_{0.1}Co_{0.1}O₂), a conductive agent (carbon black), a dispersant (N-methylpyrrolidone, ADC-01, LG Chem), and binder resins (a mixture of PVDF-HFP and PVDF) with water at a weight ratio of 97.5:0.7:0.14:1.66. Subsequently, the slurry was applied to the surface of an aluminum foil (thickness of 10 μm) and dried to prepare a positive electrode having a positive electrode active material layer with a thickness of 120 μm.

### 2) Preparation of Positive Electrode

A slurry for a negative electrode active material layer having a concentration of 50 wt % excluding water was prepared by mixing graphite (a blend of natural graphite and artificial graphite), a conductive agent (carbon black), a dispersant (polyvinylpyrrolidone, Junsei, Japan), and binder resins (a mixture of PVDF-HFP and PVDF) with water at a weight ratio of 97.5:0.7:0.14:1.66. Subsequently, the slurry was applied to the surface of a copper foil (thickness of 10 μm) and dried to prepare a negative electrode having a negative electrode active material layer with a thickness of 120 μm.

### 3) Lamination Process

An electrode assembly was obtained by laminating the separators of the Examples and Comparative Examples between the prepared positive electrode and negative electrode and performing a lamination process. The lamination process was carried out using a hot press at 60° C. and 6.5 MPa for 1 second.

### 4) Electrolyte Injection Process

The electrode assembly subjected to the lamination process was placed in a cell case, and an electrolyte of EC/DMC including 1 M LiPF₆ was injected to prepare an electrochemical device.

### (3) Evaluation of Initial Resistance of Electrochemical Device

The electrochemical devices of Examples and Comparative Examples were left standing for 3 hours, and then subjected to 0.33 C charge/0.33 C discharge cycles 5 times in a voltage range of 3.0 V to 4.2 V using a charge/discharge tester (PNE Solution). Thereafter, the resistance was measured from the results of electrochemical impedance spectroscopy using VMP3 (BioLogic Science Instrument) under the conditions of amplitude of 10 mV and scan range of 0.1 Hz to 1 MHz at 25° C. Accordingly, the initial resistance of the electrochemical devices was evaluated.

### (4) Evaluation of High-Rate Performance of Electrochemical Device

For the electrochemical devices of Examples and Comparative Examples, charge/discharge cycles were sequentially carried out in a voltage range of 3.0 V to 4.2 V using a charge/discharge tester (PNE Solution) under the conditions of 0.2 C charge/0.2C discharge for 5 cycles, 0.33 C charge/0.33 C discharge for 5 cycles, 0.5 C charge/0.5 C discharge for 5 cycles, 1 C charge/1 C discharge for 5 cycles, 2 C charge/2 C discharge for 5 cycles, and 3 C charge/3 C discharge for 5 cycles, and the capacity retention ratio at each C rate was confirmed. The capacity retention ratio was calculated as the ratio of the discharge capacity at 3 C to the discharge capacity at 0.33 C. Accordingly, the capacity retention ratio was evaluated.

The initial resistance and the capacity retention ratios are shown in Table 4 below.

TABLE 4

| | | | | | Comp. | Comp. | Comp. | Comp. |
|---|---|---|---|---|---|---|---|---|
| Parameter | Ex. 1 | Ex. 2 | Ex. 3 | Ex. 4 | Ex. 1 | Ex. 2 | Ex. 3 | Ex. 4 |
| Initial | 1.2 | 1.2 | 1.1 | 1.1 | 1.3 | 1.7 | 1.6 | 1.6 |
| resistance | | | | | | | | |
| (Ω) | | | | | | | | |
| Capacity | 70 | 70 | 73 | 73 | 65 | 45 | 50 | 70 |
| retention | | | | | | | | |
| rate (%) | | | | | | | | |

As shown in Table 4, it was confirmed that the separators for an electrochemical device of Examples had low initial resistance of the electrochemical device due to the high porosity of the porous polymer substrate and the coating layer. In contrast, it was confirmed that the electrochemical devices of Comparative Examples including separators for an electrochemical device having low porosity had high initial resistance of the electrochemical device because a bottleneck phenomenon occurred during the migration of lithium ions through the separators. In addition, since the electrochemical devices of Examples included porous polymer substrates having an excellent compressive resistance, it was confirmed that the separators for an electrochemical device maintained high porosity even after charge/discharge cycles, and thus, the capacity retention ratio was high.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A separator for an electrochemical device comprising:
a porous polymer substrate; and
a coating layer disposed on at least one surface of the porous polymer substrate and including inorganic particles,
wherein the porous polymer substrate has a porosity of 50 vol % or more and 65 vol % or less,
the porous polymer substrate includes a polymer having a melt index of 0.0001 g/10 min or more and 0.01 g/10 min or less, and
the coating layer has a porosity of 40 vol % or more and 70 vol % or less.

2. The separator for an electrochemical device according to claim 1, wherein the polymer in the porous polymer substrate has a crystallinity of 60% or more and 90% or less.

3. The separator for an electrochemical device according to claim 1, wherein the polymer in the porous polymer substrate has a weight average molecular weight of 1,500,000 g/mol or more and 2,500,000 g/mol or less.

4. The separator for an electrochemical device according to claim 1, wherein the polymer in the porous polymer substrate is one or more selected from polyethylene, polypropylene, polybutylene, polyvinyl chloride, polyethylene terephthalate, polycycloolefin, polyethersulfone, polyamide, polyimide, polyamide imide, nylon, and polytetrafluoroethylene.

5. The separator for an electrochemical device according to claim 1, wherein the inorganic particles included in the coating layer have a cubic shape.

6. The separator for an electrochemical device according to claim 1, wherein the inorganic particles included in the coating layer have an average particle diameter (D₅₀) of 200 nm or more and 1 μm or less.

7. The separator for an electrochemical device according to claim 1, wherein the inorganic particles included in the coating layer are one or more selected from boehmite (γ-AlO(OH)), alumina (Al₂O₃), BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al(OH)₃, TiO₂, aluminum peroxide, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅).

8. The separator for an electrochemical device according to claim 1, wherein a content of the inorganic particles is 90 parts by weight or more based on 100 parts by weight of the total weight of the coating layer.

9. The separator for an electrochemical device according to claim 1, wherein the coating layer further includes a binder, and
a content of the binder is 1 part by weight or more and 10 parts by weight or less based on 100 parts by weight of the total weight of the coating layer.

10. The separator for an electrochemical device according to claim 1, wherein a thickness of the porous polymer substrate is 4 μm or more and 20 μm or less.

11. The separator for an electrochemical device according to claim 1, wherein a thickness of the coating layer is 0.5 μm or more and 4 μm or less.

12. An electrochemical device comprising:
a positive electrode;
a negative electrode; and
the separator for an electrochemical device according to claim 1,
wherein the separator is interposed between the positive electrode and the negative electrode.

13. A method for manufacturing a separator for an electrochemical device, the method comprising:
extruding a polymer sheet composition including a polymer and a diluent;
molding and stretching the extruded polymer sheet composition into a sheet form;
extracting the diluent from the stretched polymer sheet to prepare a porous polymer substrate;
heat-setting the porous polymer substrate; and
forming a coating layer including inorganic particles on at least one surface of the porous polymer substrate,
wherein the polymer of the porous polymer substrate has a melt index of 0.0001 g/10 min or more and 0.01 g/10 min or less, and
a content of the diluent is 70 parts by weight or more and 90 parts by weight or less based on 100 parts by weight of the total polymer sheet composition.
